(19) United States
(12) Patent Application Publication
(10) Pub. No.: US 2011/0108291 A1
(43) Pub. Date: May 12, 2011

(54) SPARY DEVICE AND OPERATION METHOD THEREOF

(76) Inventor: Tie fu Han, Fujian (CN)

(21) Appl. No.: 12/737,440

(22) PCT Filed: Jul. 13, 2009
(86) PCT No.: PCT/CN2009/072734

§ 371 Date: Jan. 12, 2011

(30) Foreign Application Priority Data
Jul. 12, 2008 (CN) 200810071397.8
Sep. 6, 2008 (CN) 200810071716.5

(51) Int. Cl. A62C 2/00; B05B 12/10

(52) U.S. Cl. 169/46; 239/75

(57) ABSTRACT

A spray device includes a normally closed valve, and a spray head having a spray nozzle, wherein the valve includes a valve body, a piston element, a thermal sensitive mechanism having a thermal sensitive element and a bracket supporting the thermal sensitive mechanism. The valve body has an inlet chamber, a control chamber, and an outlet chamber. The spray device normally operates in a standby state in which the thermal sensitive mechanism is arranged to press against the piston element which is driven to block physical access between the inlet chamber and the outlet chamber. The control chamber is located at a lateral position of the outlet chamber in such a manner that axes of the control chamber and the outlet chamber are approximately perpendicular to each other. The spray head has an atomizing chamber, and is supported for such as to avoid the thermal sensitive mechanism from being blocked.

### CROSS REFERENCE OF RELATED APPLICATION

The present application claims the benefit of priority to PCT/CN2009/072734 titled “Spray Device” filed on Jul. 13, 2009, which claims the benefit of priority to Chinese patent application No. 200810071397.8 titled “DISPENSING DEVICES WITH PRE-DISPOSED HEAT-SENSITIVE MECHANISM AND ITS USE METHOD”, filed with the Chinese State Intellectual Property Office on Jul. 12, 2008, and the benefit of priority to Chinese patent application No. 200810071716.5 titled “CLOSED TYPE SPRAY CONTAINER WITH PRESSURE-REDUCING HEAT-SENSITIVE MECHANISM AND METHOD OF USE THEREOF”, filed with the Chinese State Intellectual Property Office on Sep. 6, 2008. The entire disclosure thereof is incorporated herein by reference.

### BACKGROUND OF THE PRESENT INVENTION

1. Field of Invention

The present invention relates to fire-fighting equipment, and particularly to a spray device and an operation method thereof.

2. Description of Related Arts

Conventionally, there is a sprinkling device provided at the end of an automatic fire extinguishing system pipeline. The sprinkling device includes a spray head. A fire extinguishing agent is sprayed by the spray head to extinguish fire. A closed type sprinkling device is usually used in a closed type fire extinguishing system, to automatically open the spray head near the fire source.

The conventional closed type sprinkling device includes a valve body, a water inlet and a water outlet blocked by a seal disk. A supporting arm fixed to the valve/body and a water splash disk is provided outside the water outlet. A thermal sensitive element is provided between the seal disk and the supporting arm. One end of the thermal sensitive element is supported at the center of the supporting arm, and the other end thereof abuts against the seal disk. The thermal sensitive element is heated and then broken, fallen off. The seal disk is fallen off under the water pressure of the water outlet, and water is sprayed out from the water outlet and sprinkled around by the splash disk, so as to achieve the automatic sprinkling of the closed type sprinkling device. However, such splash sprinkling device only sprinkles water, and cannot spray mist or fine water mist.

Since the thermal sensitive element, the supporting arm and the splash disk of the closed type sprinkling device are located opposite to the outlet, the supporting arm and the splash disk would disadvantageously affect the atomization of the jetted water when water is jetted from the water outlet. On the one hand, it would affect the flow direction and dispersion fineness of water, thereby affecting the fire extinguishing effect. On the other hand, since the seal disk is located at a position of the water outlet in the axis of the of the normally closed valve of the sprinkling device, and the supporting arm and the splash disk are located outside the water outlet, it is difficult to provide an atomizing nozzle or any of other atomizing devices at the water outlet, such that it is difficult for the conventional closed type sprinkling device to spray mist.

Chinese patent No. 99105898.4 discloses a closed type sprinkling device including a thermal sensitive element, a bar-shaped arm, a hook-shaped connecting member and a seal ball. In the closed type sprinkling device, the thermal sensitive element and the bar-shaped arm are located at the outer side of the normally closed valve, instead of the center of the normally closed valve, but the hook-shaped connecting member and the seal ball are still required to block the outlet of the normally closed valve, so that the shape and the structure of the nozzle are seriously limited and it is difficult to spay mist. Besides, such sprinkling device cannot be made as a multi-nozzle closed type spray device. Chinese patents No. 95195067.3 and No. 200520117602.1 disclose two closed type spray solutions. In the former patent, the central nozzle is provided at the end of the spindle which faces thermal sensitive element, but the central spray is still blocked by the thermal sensitive element and the supporting arm, which has a poor spray effect and only suitable for a high pressure liquid spray. In the latter patent, a medium-low pressure closed type fine water mist spray head structure is provided, and a plurality of nozzles located at the periphery and inclined towards the center are used to spray towards the center to compensate a spray blank space caused by the position of the thermal sensitive mechanism. However, since the thermal sensitive element and the supporting arm are still located at the outlet, it is impossible for the above solutions to completely eliminate the disadvantageous influence of the thermal sensitive element and the supporting arm on the spray effect.

In addition, the thermal sensitive element of the conventional closed type sprinkling device is directly subject to the inlet fluid pressure of the sprinkling device, so thermal sensitive mechanism cannot withstand the high pressure due to the limited strength of the thermal sensitive element. As a result, it is only suitable for a working condition of the medium-low pressure and cannot be applied to a high pressure sprinkling and spray. This further limits the application of the sprinkling device, and causes the disadvantageous influence on the fire extinguishing effect. The fine water mist fire extinguishing is a new technology which extinguishes fire with thick water mist micro drops. It can extinguish many types of large-scale fire merely by using a small quantity of water, and has some prominent advantages such as a low cost, no water stain, being beneficial to escape for personnel, which is urgently required to be extended in application. However, the key member such as the fine water mist closed type spray head is difficult in development. It is difficult to solve the problem that there is a structure contradiction between the conventional normally closed type thermal sensitive mechanism and the fine mist spray nozzle. Besides, the quality of the high pressure spray is good, but the thermal sensitive element that normally closes the spray head cannot withstand the high pressure. In order to reduce the pressure applied on the thermal sensitive element, the structure of the conventional high pressure normally closed type thermal sensitive spray head is complex, which limits the spray and affects the fire extinguishing ability. This also is a difficult problem to be solved.

### SUMMARY OF THE PRESENT INVENTION

The invention is advantageous in that it provides a solution to resolve the problems of the poor spray of the conventional closed type spray head and the structure contradiction between the closed type thermal sensitive mechanism and the spray nozzle. A normally closed type thermal sensitive spray device used for the automatic fire extinguishing pipeline terminal is provided, which may eliminate the disadvantage that the thermal sensitive mechanism and the supporting arm at the outlet of the conventional closed type spray head may hinder the spray, and significantly improve the spray performance of the closed type spray head, widen the application scope of the closed type spray head, and develop a new closed type spray method, so as to enhance the automatic fire extinguishing performance and the fire extinguishing effect of the fire fighting system.

Another advantage of the invention is to provide a new high pressure closed type spray device, in which the closed type spray device with the pre-disposed thermal sensitive mechanism may applied in the medium-high pressure system. Additional advantages and features of the invention will become apparent from the description which follows, and may be realized by means of the instrumentalities and combinations particular point out in the appended claims.

According to the present invention, the foregoing and other objects and advantages are attained by providing a sprinkling device with the pre-disposed thermal sensitive mechanism having a normally closed valve, and at least one spray head/nozzle. The normally closed valve is provided with a valve body, a piston element, a thermal sensitive mechanism and a bracket. The valve body is provided with an inlet chamber, a control chamber and at least one big-hole outlet chamber. The control chamber is provided at the downstream of the inlet chamber and the upstream of the outlet chamber, and is located at a lateral position of the outlet chamber. The outlet chamber communicates with the inlet chamber via the control chamber. The inlet chamber is connected with a pressure flow source. The outlet chamber communicates with the spray head/nozzle. A slidable piston element is provided in the control chamber. An end cover with a through hole is provided at the outer end of the control chamber. The thermal sensitive mechanism and the bracket are provided outside the control chamber. The bracket is fixedly connected to the valve body or end cover, and supports the thermal sensitive mechanism. The thermal sensitive mechanism presses against the tail of the piston element located in the through hole of the end cover. The head of the piston element seals the communication portion between the inlet chamber and the outlet chamber. Still further objects and advantages will become apparent from a consideration of the ensuing description and drawings.

Another sprinkling device is provided with a valve body, a piston element, a thermal sensitive mechanism, a bracket and at least one spray head/nozzle. The valve body is provided with an inlet chamber, a control chamber and at least one big-hole outlet chamber. The inlet chamber is connected with a pressure flow source, and the outlet chamber communicates with the spray head/nozzle. A fluid passage is formed form the inlet chamber, through the control chamber to the outlet chamber. The thermal sensitive mechanism and the bracket are provided at the outer end of the control chamber. A piston element is provided in the control chamber, to hermetically isolate the control chamber and outlet chamber from the atmosphere. A pressure pilot hole communicating the inlet chamber and the control chamber is provided in the piston element, to reduce the pressure applied on the thermal sensitive mechanism. The piston element is slidably provided in the control chamber, and formed of the piston head and the piston rod. The bracket fixed on the valve body supports the thermal sensitive mechanism. The thermal sensitive mechanism presses against the tail of the piston rod, so that the piston head is positioned at the inner end of the control chamber and seals the fluid passage between the inlet chamber and the outlet chamber. A seal member is provided between the piston head and the wall of the control chamber, and another seal member may be provided between the piston rod and the through hole of the outer end of the control chamber. A piston rod chamber is formed between the piston rod and the control chamber. The pressure pilot hole communicates the inlet chamber and the piston rod chamber. The circular area of the front surface of the piston head withstanding the fluid pressure is larger than the annular area of the piston rod chamber, i.e. the annular area of the back surface of piston head withstanding the fluid pressure, and the fluid pressure directions applied on the front surface and back surface of the piston head are reverse.

The control chamber of the valve body is located at lateral positions of respective outlet chambers of the valve body. The through hole at the outer end of the control chamber is provided in the end cover which is an independent end cover, or is an end cover of the bracket. The end cover and the control chamber are threadedly connected together.

The piston head of the piston element is of a cylindrical shape with the top of a circular plat surface or conical surface or hemispherical surface. The pressure pilot hole provided in the piston element is a through hole provided in the piston head or a through hole in the piston head and piston rod. A seal member is provided on the piston element, or seal members are provided on the piston element and control chamber, or seal members are provided on the piston element and end cover, to hermetically isolate the inlet chamber and the piston rod chamber from the outlet chamber and the atmosphere.

The medium-high pressure water automatic fire extinguishing system is referred to that, for the working pressure of the pipeline network and the valve body of the sprinkling device, the medium pressure is larger than 1.21 MPa, and the high pressure is larger than 3.5 MPa.

The valve body may be an integral valve body or a detachable assembled valve body. The detachable assembled valve body is provided with an outer casing body and a middle body. The outer casing body is surroundingly installed on the middle body provided with an inlet chamber and the end cover. An annular chamber is formed between the middle body and the outer casing body, and a control chamber is formed between the middle body and the end cover. The annular chamber surrounds the periphery of the control chamber. The annular chamber communicates with the outlet chamber.

Preferably, a spring is provided in the control chamber, wherein one end of the spring is in contact with the end cover, and the other end of the spring is in contact with the piston element. The spring may timely push the piston element to return in position so as to close the normally closed valve when the pressure loss of the system occurs, so that the normally closed valve is prevented from leaking.

The thermal sensitive mechanism may be a separate thermal sensitive element, or a supporting bar component having a rapid response function and having the thermal sensitive element for assisting the support.

Preferably, a rapid response thermal sensitive wire is provided on the thermal sensitive element, wherein one end of the rapid response thermal sensitive wire is connected with the thermal sensitive element, and the other end is an external terminal.

The outlet chamber communicates with the spray head/nozzle directly or by a connecting member. The connecting member may be a variety of a fluid transmission pipes, a bearing and a rotary connector.

According to the movement mode of the spray head, the spray head may be a fixed spray head or rotary spray head. According to the spray flow state sprayed from the spray nozzle, the spray nozzle communicating with the outlet chamber may be a fine water mist spray nozzle, a gas-water mist spray nozzle, water mist spray nozzle, or a foam mist spray nozzle.

The spray nozzle communicating with the outlet chamber is the foam mist spray nozzle. The foam mist spray nozzle may be a pure atomization spray nozzle or a foam spray head mixing air at the outlet of the spray nozzle. The foam spray head mixing air at the outlet of the spray nozzle is provided with a spray head seat, a spray head body with a congregation jet flow spray nozzle and a spray head cover. The congregation jet flow spray nozzle and spray head cover form a venturi air mixing spray structure. The spray head cover is provided with a connecting thread as well as a multi-hole air suction chamber, a shrinkage guiding inlet, a mixing tube and a diffuse tube. A secondary air suction hole or/and small bubble web may be additionally provided on the diffuse tube.

According to the structure of the atomizing core, the spray nozzle communicating with the outlet chamber may be a centripetal rotational flow atomizing core spray nozzle, a double rotational flow double atomizing core spray nozzle, a spring conical plug atomizing core spray nozzle, a mutual colliding flow or rotor mutual colliding flow atomizing core spray nozzle or other fine water atomizing core spray nozzles. The mutual colliding flow atomizing core spray nozzle is provided with a spray head seat and a spray head body. Multiple groups of mutual colliding flow holes are provided on the spray head body. The axes of the mutual colliding flow holes meet with each other or in group. The rotor mutual colliding flow atomizing core spray nozzle is a spray nozzle that the axes of the mutual colliding flow holes meet with each other and a rotor is provided therein. The fine water mist mentioned in the present invention is referred to water mist having mist drop of a total volume percent DV0.99 less than 1000 μm.

The operation method of the spray device includes a general independent operation method, an extended operation method in which one normally closed valve has an open spray head/nozzle, and a cross-connection combination operation method in which at least two normally closed valves are used in combination.

For the general independent operation method, the inlet chamber of each set of closed type spray device is connected to the terminal end of one branch pipe of the fire extinguishing pipe network, and the outlet chambers of the each closed type spray device directly communicate with the spray nozzles or spray heads.

For the extend operation method, the inlet chamber of each normally closed valve is connected to the terminal end of one branch pipe of the fire extinguishing pipe network, a portion of outlet chambers of individual normally closed valve are connected to the spray nozzles or spray heads by pipelines, and the other outlet chambers are directly connected to the spray heads/nozzles. Such use method may extend the protection scope of one single closed type spray device. For example, the spray device with a thermal sensitive mechanism is placed at a dangerous monitoring position, and a portion of outlet chambers of the normally closed valve of the spray device is connected to an open fine water mist spray nozzles or spray heads provided near a door/window by pipelines, (because hot air flow of fire hazard causing the action of the thermal sensitive mechanism is generally lagged when arriving the door/window position, so that the closed type spray head device provided thereat cannot timely respond) which is useful to timely protect the door/window of a high building from vigorous burning and is benefit to escape when fire.

For the cross-connection combination operation method, the inlet chamber of each normally closed valve is connected to the terminal end of one branch pipe of the fire extinguishing pipe network, one outlet chamber of each of the at least two normally closed valves communicates with each other by pipelines, and the other outlet chambers of the normally closed valves are directly connected to the spray heads/nozzles. Alternatively, a majority of outlet chambers of the normally closed valves are directly connected to the spray heads/nozzles, a minority of outlet chambers are connected with each other by pipelines. Thus, the thermal sensitive mechanism of each normally closed valve of the closed type spray devices communicating with each other by pipelines may control all spray nozzles of the normally closed valves communicating with each other. Such use method is different from the open fire extinguishing system in which all spray heads in the whole space spray simultaneously. In such operation, the normally closed valve at the fire position firstly actuated induces several spray heads or spray nozzles in a small scope therearound to spray simultaneously. Therefore, at the beginning of the fire hazard, the thermal sensitive mechanism firstly acting may induce several spray heads or spray nozzles around the fire point to extinguish fire simultaneously, which has advantageous such as extinguishing fire effectively and early, having a flexible configuration, saving water, reducing installed capacity of fire extinguishing equipment and saving cost, and thus may applied in the fine water mist or foam spray automatic fire extinguishing system, and some large fire fighting zone may be divided into small zones or rooms, so as to perform a grouping protection.

The operation process of the spray device according to the present invention is briefly described as follows.

When a temperature in a monitor region environment is beyond a predetermined temperature, the thermal sensitive element falls off, and the piston element of the normally closed valve slides backwardly under fluid pressure, so that a pressure fluid flows from the inlet chamber of the normally closed valve into the outlet chamber via the control chamber, and then is sprayed out from the spray nozzle or spray head to extinguish fire; after fire extinguishing, the piston element is returned in position and a thermal sensitive element is installed again to prepare for next spray.

Compared with the prior art, the present invention has the following prominent advantages and notable effects.

Since the spray device according to the present invention has the pre-disposed thermal sensitive mechanism, that is, the control chamber is located at the lateral position of the outlet chamber, and is located at the upstream of the outlet chamber of the normally closed valve of the sprinkling device, the installation position of the thermal sensitive mechanism of the normally closed valve may completely avoid the spray opening of the spray device, thereby not interfering the spray of the spray nozzle, and facilitating to the design of the structure of the spray device, so that the spray device may be varied. In addition, many kinds of new spray devices may be researched and developed on the basis of the structure features of the present invention, though the research and development of new closed type spray heads have been limited by conventional structure. Since the present invention may be used in single or flexible combination, various forms of spray nozzles may be adopted according to the requirement, and may be disposed at the periphery of the normally closed valve or at the position away from the normally closed valve according to the requirement, and the normally closed valve still may control the operation of the spray nozzle. Especially, the normally closed valves of several spray devices of the present invention may communicate with each other, to form a linking-action spray device in a small scope. The action of thermal sensitive mechanism of any of the normally closed valves in this small scope may actuate all spray nozzles in the small scope to spray simultaneously, so the spray scope and fire extinguishing intensity may be increased under a particular situation, and the spray forms may be varied, which has a wide application. Besides, since the normally closed valve is provided with the rapid response thermal sensitive mechanism, and the rapid response thermal sensitive wire may also be provided on the thermal sensitive element of the thermal sensitive mechanism, the response ability to the fire hazard is significantly improved, and the response is quick and reliable.

The closed type spray device with the pressure-reducing thermal sensitive mechanism is provided at the terminal end of each branch path of the pipe network of the automatic fire extinguishing system, and may spray automatically depending on the sensed temperature, and may be used in the medium-high pressure closed type fire extinguishing system which extinguishes fire by spraying fine water mist, gas fine water mist or water spray or foam spray. Since the pressure pilot hole communicating the inlet chamber and the piston rod chamber is provided in the piston element of the closed type spray device with the pressure-reducing thermal sensitive mechanism, the piston rod chamber and the inlet chamber are in communication with each other and are applied with the same fluid pressure. Since the downward fluid pressure applied on the front surface of the piston head is slightly larger than the upward fluid pressure applied on the back surface of the piston head, the fluid pressure applied on the front surface of the piston head is mostly counteracted by the fluid pressure applied on the back surface of the piston head. However, in the prior art, the thermal sensitive mechanism is subject to all fluid pressure applied on the front surface of the piston head. Therefore, the force applied on the thermal sensitive mechanism of the closed type spray device according to the present invention is greatly reduced, and thus the general thermal sensitive element may support the piston element used in medium-high pressure fluid environment so as to close the spray device. When the thermal sensitive element falls off and the piston element loses support, the piston element is moved downwardly under the fluid pressure difference between the front surface and the back surface of the piston head, meanwhile, the fluid in the piston rod chamber is pushed into the control chamber of the front surface of the piston head, and the flow rate pushing the piston element to move downwardly is increased, so as to push the piston element to move downwardly, and open the passage of the control chamber, so that the fluid in the inlet chamber quickly enters into the outlet chamber to be sprayed. Since the structure of the pressure pilot hole of the present invention may not only greatly reduce the force applied on the thermal sensitive mechanism, but also effectively reduce the pressure applied on the thermal sensitive element for supporting the piston element, it is possible to support and control the operation of the high pressure normally closed valve with a thinner thermal sensitive element having a low strength. Therefore, the response ability of the closed type spray device of the present invention may be improved in two ways, i.e. i) on one hand, the actuation time to reach the same predetermined temperature is shortened by using a thinner thermal sensitive element having a low strength, ii) on the other hand, the actuation speed of the closed type spray device may be accelerated by the piston element. As can be seen, the closed type spray device with the pressure-reducing thermal sensitive mechanism according to the present invention is particularly suitable to the medium-high pressure water closed type automatic fire extinguishing system, and the pressure-reducing thermal sensitive mechanism according to the present invention may also be applied to a big diameter thermal sensitive normally closed valve in the medium-low pressure water closed type automatic fire extinguishing system, so as to reduce the pressure applied on the thermal sensitive element which may stop the passage having a relatively large area only by a strong support.

The present invention is, an improvement of the conventional structure of the closed type sprinkling device, and solves the difficult problem that the conventional thermal sensitive mechanism would interfere the spray of the spray nozzle. The solution of the present invention that the control chamber is provided at the lateral position of each outlet chamber of the valve body, extends the function of the closed type spray device, and increases the spray quality. In order to further increase the ability of quickly opening the closed type spray device, the present invention designs and provides the rapid response thermal sensitive mechanism. In order to increase the fire extinguishing ability, the closed type spray device of the present invention provides a new closed type valve body with a plurality of outlet chambers and a spray structure disposed in combination, as well as a new atomization spray nozzle which may applied in various fire hazards. In order to enlarge the protection scope, the present invention provides a new use method in which several closed type spray devices are used in combination. Therefore, the present invention has prominent advantages and effects, such as, not interfering the spray of the spray nozzle by the bracket, fine mist, large flowrate, good spray effect, various spray forms and space distribution, appropriate and flexible combined fire fighting scope, quick response, wide applicability, and suitable to various working conditions of the high, medium, low pressure. The present invention also provides new technical solutions such as rotary spray and foam spray thermal sensitive closed type device and partially closed type spray system. These and other objectives, features, and advantages of the present invention will become apparent from the following detailed description, the accompanying drawings, and the appended claims.

### BRIEF DESCRIPTION OF THE DRAWINGS

The present invention will be further described in detail with reference to drawings and specific embodiments as mentioned below.

FIG. 1 is a schematic structural exploded view of embodiment 1 of a spray device with pre-disposed heat-sensitive mechanism according to the present invention.

FIG. 2 is a schematic structural view of embodiment 2 of a spray device with pre-disposed heat-sensitive mechanism according to the present invention.

FIG. 3 is a schematic structural view of embodiment 3 of a spray device with pre-disposed heat-sensitive mechanism according to the present invention.

FIG. 4 is a schematic structural exploded view of embodiment 4 of a spray device with pre-disposed heat-sensitive mechanism according to the present invention.

FIG. 5 is a schematic structural exploded view of embodiment 5 of a spray device with pre-disposed heat-sensitive mechanism according to the present invention.

FIG. 6 is a view seeing from direction D in FIG. 5.

FIG. 7 is a schematic structural exploded view of embodiment 6 of a spray device with pre-disposed heat-sensitive mechanism according to the present invention.

FIG. 8 is a schematic section view along line B-B in FIG. 7, illustrating the spray.

FIG. 9 is a schematic structural exploded view of embodiment 7 of a spray device with pre-disposed heat-sensitive mechanism according to the present invention, illustrating the combination use of normally closed valves of the spray device with pre-disposed heat-sensitive mechanism.

FIG. 10 is a schematic structural view of a gas-water mist spray head.

FIG. 11 is a schematic structural view of a fine water mist spray head.

FIG. 12 is a schematic structural view of a centripetal rotational flow atomizing core spray nozzle.

FIG. 13 is a section view along line K-K in FIG. 12.

FIG. 14 is a schematic structural view of a double rotational flow atomizing core spray nozzle.

FIG. 15 is a schematic structural view of a rotor mutual colliding flow atomizing core spray nozzle.

FIG. 16 is a schematic structural view of an atomizing core spray nozzle with a spring conical plug.

FIG. 17 is a schematic section view along line F-F in FIG. 9.

FIG. 18 is a schematic structural view of a water mist spray head.

FIG. 19 is a schematic structural view of a foam mist spray head.

FIG. 20 is a schematic structural view of a big water drop spray head.

### DETAILED DESCRIPTION OF THE PREFERRED EMBODIMENT

It should be noted that, in the description that follows, the spray nozzle is referred to a small spray unit which includes an atomizing chamber/core and its spray orifice and is provided on a solid body, and the spray head is a carrier including the spray nozzle. For the sake of clarity, the spray head and the spray nozzle are collectively referred to as the spray nozzle.

In addition, in the present patent application, the outlet chamber provided in the valve body includes a big-hole outlet chamber capable of communicating with a pipe member or the spray head, and a small-hole outlet chamber communicating with the spray nozzle on the valve body. The pipe member mentioned herein includes some joints such as bends and tee-fittings, and pipelines. For the sake of clarity, the big-hole outlet chamber and the small-hole outlet chamber are not separately described, and are collectively referred to as the outlet chamber.

### Embodiment 1

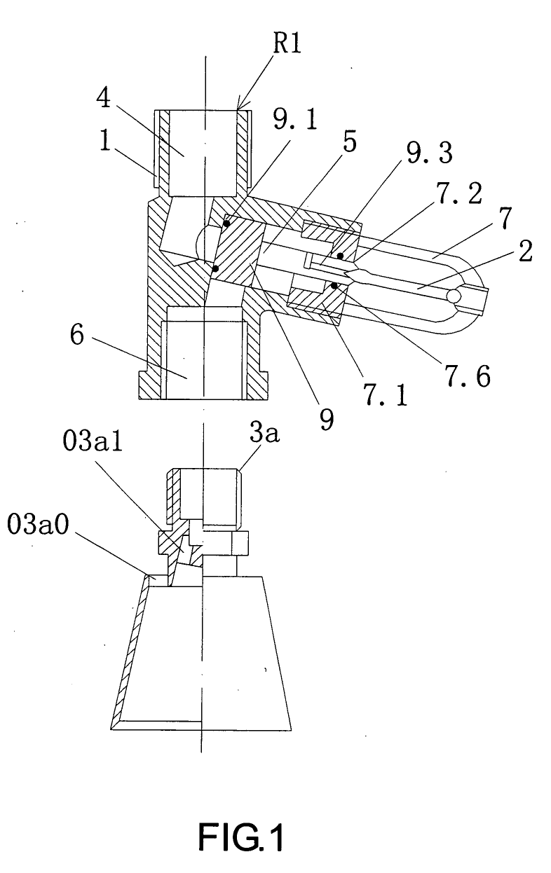

Referring to FIG. 1 of the drawings, in the present invention, the spray device according to embodiment 1 includes a normally closed valve R1 and a spray head 3a. The normally closed valve R1 is provided with a valve body 1, a thermal sensitive mechanism, a bracket 7 and a piston element 9. An outlet chamber 6 of the normally closed valve R1 is directly connected with the spray head 3a by thread.

The valve body 1 is provided with an inlet chamber 4, a control chamber 5 and the outlet chamber 6. The control chamber 5 is disposed between the inlet chamber 4 and the outlet chamber 6, the inner end of which is arranged to communicate with the inlet chamber 4 and the outlet chamber 6. The control chamber 5 is located at a lateral position of the outlet chamber 6, that is, an inclination angle (the inclination angle may less than, equal to, or larger than 90 degree) would be formed by intersecting between the axis line of the control chamber 5 and the axis line of the outlet chamber 6. Meanwhile, the axis line of the control chamber 5 and the axis line of the inlet chamber 4 intersect with each other and are in the same plane. The thermal sensitive mechanism is a separate thermal sensitive element 2. The thermal sensitive element 2 is thermal sensitive glass bulb (which may also be a fusible alloy component and so on), and is exposed to ambient atmosphere. An end cover 7.1 is provided at the outer end opening of the control chamber 5, and is fixedly connected with the outer end opening of the control chamber 5 of the valve body 1 by thread. The end cover 7.1 is provided with a central hole 7.2 and a seal member 7.6. The bracket 7 is fixedly connected on the end cover 7.1. The piston element 9 is of a piston shape, and is slidably provided in the control chamber 5. A seal member 9.1 is provided at the head of the piston element 9 which presses against a communication portion between the inlet chamber 4 and the control chamber 5. The tail of the piston element 9 is located in the central hole 7.2 of the end cover 7.1, and provided with a small air hole 9.3 which allows a smoother slide of the piston element 9. One end of the thermal sensitive element 2 is supported on the bracket 7, and the other end of the thermal sensitive element 2 abuts against the piston element 9. The spray head 3a is fixed foam spray head (which may also be replaced by other fixed spray heads, rotary spray heads), and provided with a central big hole, a plurality of small offset holes 03a1 and a plurality of foam atomization air access holes 03a0. The central big hole and the small offset holes 03a1 form a combination spray opening. The offset holes 03a1 are spacedly provided along the circumference of the spray head 3a. The foam atomization air access holes 03a0 are spacedly provided along the circumference of the spray head 3a, and communicate with atmosphere. In actual application, the number of the offset holes and the foam atomization air access holes may be designed according to a requirement.

The spray device with pre-disposed thermal sensitive mechanism according to the embodiment may be referred to as a closed type foam spray head. A filter (not drawn in figures) may be provided at the inlet of the spray head according to the circumstances in which the present invention is utilized, and a filter (not drawn in figures) may also be provided in the inlet chamber 4 of the valve body 1 according to the requirement.

The operation of the spray device is as follows: when a temperature in a monitored region is above a predetermined temperature, the thermal sensitive element 2 falls off, and the piston element 9 of the normally closed valve R1 slides backwardly under fluid pressure, so that a pressure fluid flows from the inlet chamber 4 of the normally closed valve R1 into the outlet chamber 6 via the control chamber 5, then into the spray head 3a, and finally is sprayed out from the spray head 3a to extinguish fire. After spraying of the water, the piston element 9 is returned in position and a new thermal sensitive element 2 is installed again manually to prepare for next spray.

### Embodiment 2

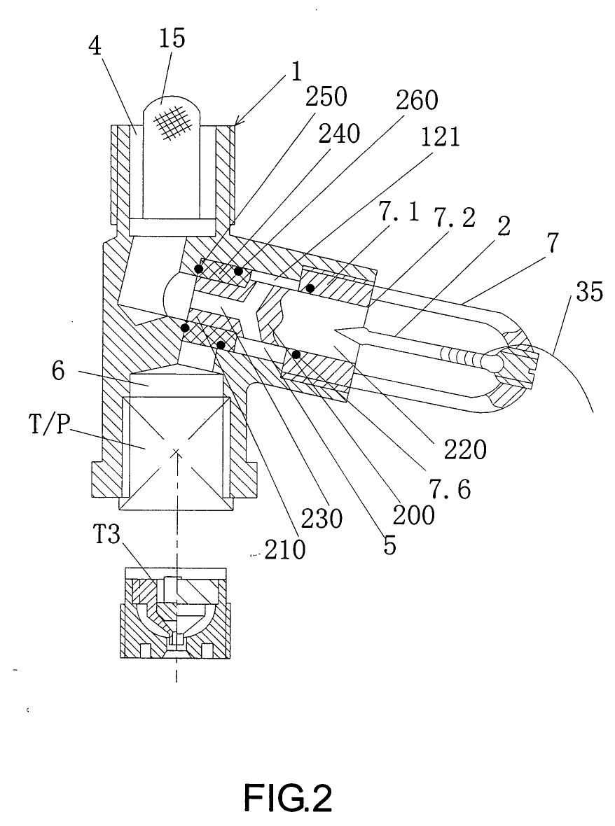

Referring to FIG. 2 of the drawings, the spray device according to this embodiment includes the normally closed valve R1 and the spray head. The spray head in the embodiment may be a spray head P in which an atomizing core spray nozzle T is provided. The normally closed valve R1 includes the valve body 1, a piston element 200, the thermal sensitive mechanism (being the separate thermal sensitive element 2) and the bracket 7. The valve body 1 is provided with the inlet chamber 4, the control chamber 5 and the outlet chamber 6. The inlet chamber 4 is connected to an outer pressure flow source, and provided with the filter 15 (which may be provided according to the requirement). The outlet chamber 6 communicates with the spray head P or atomizing core spray nozzle T by a thread connection. The control chamber 5 is provided at a lateral position between the inlet chamber 4 and the outlet chamber 6. A piston element 200 is provided in the control chamber 5. The piston element 200 supported by the thermal sensitive mechanism closes a fluid passage formed of the inlet chamber 4, control chamber 5 and outlet chamber 6. When the thermal sensitive element 2 causes an action of the piston element 200, fluid is finally sprayed in mist form from the spray head P or spray nozzle T. The outer end opening of the control chamber 5 is threadedly connected with the end cover 7.1 having the central hole 7.2. The piston element 200 is slideably provided in the control chamber 5. The piston element 200 is provided with a piston head 210 and a piston rod 220. The piston head 210 abuts against the communication portion between the inlet chamber 4 and the control chamber 5. The piston rod 220 is located in the central hole 7.2 of the end cover 7.1, and engaged with the central hole 7.2 in a slidable and sealing manner. A closed piston rod chamber 121 is formed between the piston rod 220 and the inner wall of the control chamber 5. The piston element 200 is provided with a pressure pilot hole 230 communicating the inlet chamber 4 with the control chamber 5. The bracket 7 and the thermal sensitive element 2 are disposed outside the control chamber 5. The bracket 7 is disposed on the end cover 7.1 which also serves as the base of the bracket 7. One end of the thermal sensitive element 2 is disposed on the bracket 7, and the other end of the thermal sensitive element 2 abuts against the tail of the piston rod 220. The circular area (i.e., the circular area within the seal ring on the front surface of the piston head 210) of the front surface (i.e., the surface facing the inlet chamber 4) of the piston head 210 withstanding the fluid pressure, is larger than the annular area (i.e., cross section area of the piston rod chamber 121) of the back surface of piston head 210 withstanding the fluid pressure. The fluid pressure difference between the front surface and the back surface of the piston head 210 and the thermal sensitive element 2 together provide a support force balance for the piston element 200. Thus, the pressure applied on the tail of the piston rod 220 by the thermal sensitive element 2 (being a thermal sensitive glass bulb in this embodiment) is greatly reduced, and effectively reduce the pressure on the thermal sensitive mechanism supporting the piston element 200, so that the thermal sensitive element 2 having a low strength may be used to support and control the operation of the high pressure normally closed valve so as to perform a high pressure spray. As can be seen, the embodiment of the present invention may be applied to a medium-high pressure operating condition.

The control chamber 5 of the valve body 1 is located the lateral position of outlet chamber 6 of the valve body. A piston head sleeve 240 and seal rings 250 and 260 are provided on the piston head 210. A seal ring 7.6 is provided on the end cover 7.1.

A rapid response thermal sensitive wire 35 is provided on the thermal sensitive element 2, and has one end connected to the thermal sensitive element 2 and the other end which is an external terminal far from the valve body 1.

P connected with the outlet chamber 6 and T provided in P may have various forms. For example, T may be a gas-water mist spray nozzle, or may be a fine water mist atomizing core spray nozzle, specifically may be a double rotational flow atomizing core spray nozzle T3. T3 and the solid body outside T3 form a double rotational flow atomizing core spray head (for the specific structure thereof, please referring to FIG. 14 and the following description). The working principle of embodiment 2 is the same as that of embodiment 1, except that the force applied on the thermal sensitive element 2 in embodiment 2 is smaller and thus the spray device in embodiment 2 may be used in the high pressure application to increase the fire extinguishing function of the spray device. The valve body of the normally closed valve used in the embodiment is in R1 form, but may be in R2 or R3 form or a valve body in other forms. As long as a piston-shaped piston element with a pressure pilot through hole is provided in its control chamber, the pressure applied on the thermal sensitive mechanism supporting the piston element may be reduced.

In the following embodiments, the spray devices are described by taking the non-pressure-reduced thermal sensitive control structure in embodiment 1 as an example. Of cause, the pressure-reduced thermal sensitive control structure in embodiment 2 may also be used, so that the spray device may be used in the high pressure application. The spray device adopting the piston element structure in embodiment 2 will not be described repeatedly.

### Embodiment 3

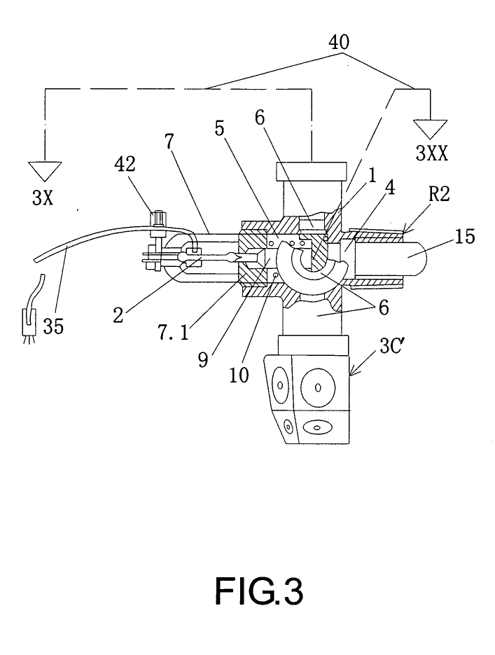

Referring to FIG. 3 of the drawings, this embodiment is similar to embodiment 1, but the differences are that: the valve body 1 of the normally closed valve R2 of the spray device is a multi-way body, the valve body 1 is provided with 2 big-hole outlet chambers 6 (the number of the outlet chambers 6 may be determined according to the requirement), the control chamber 5 is perpendicular to the outlet chambers 6, and the control chamber 5 is provided at the lateral position of the outlet chambers 6. The filter 15 (which may be provided according to the requirement) may be provided in the inlet chamber 4. A spring 10 may be provided between the piston element 9 and the end cover 7.1, one end thereof being in contact with the end cover 7.1, and the other end thereof being in contact with the piston element 9. The spring 10 facilitates the press and return of the piston element 9. One outlet chamber 6 at the lower portion of the valve body 1 is directly connected to a spray head 3C′ (the spray head 3C′ is a fine water mist sidewall spray head, or may be other kinds of spray head), and the other outlet chambers 6 are connected to fixed spray head 3X via fluid transmission pipes 40. The thermal sensitive mechanism of the normally closed valve R2 is the separate thermal sensitive element 2. The rapid response thermal sensitive wire 35 is provided on the thermal sensitive element 2, and may be a rapid thermal conduction-pilot burning wire (which also may be a thermal shock tube, or a micro-detonation detonating tube and so on). One end of the rapid response thermal sensitive wire 35 is connected with the thermal sensitive element 2 by a pipe clip 42, and the other end is an external terminal. In the embodiment, one thermal sensitive element 2 may control a plurality of outlet chambers 6, and thus control a plurality of spray nozzles to spray.

### Embodiment 4

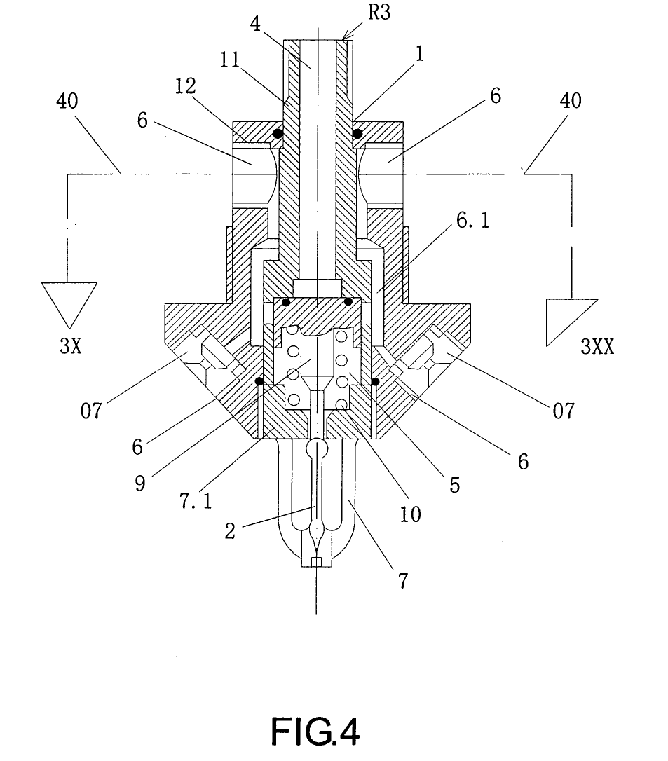

Referring to FIG. 4 of the drawings, the valve body 1 of the normally closed valve R3 of the spray device according to the embodiment 4 is a detachable assembled valve body. The valve body 1 includes an outer casing body 12, a middle body 11 and the end cover 7.1. The middle body 11 is provided with the inlet chamber 4. The control chamber 5 is formed between the middle body 11 and the end cover 7.1. The outer casing body 12 is surroundingly installed on the middle body 11 and the end cover 7.1. An annular chamber 6.1 is formed between the middle body 11 and the outer casing body 12, and surrounds the circumference of the control chamber 5. The bracket 7 supports the thermal sensitive element 2. The thermal sensitive element 2 and the spring 10 together abut against the piston element 9, to block the path from the inlet chamber 4 to the control chamber 5. Slotted holes are provided in the outer casing body 12 and the middle body 11, in order to communicate the control chamber 5 and the annular chamber 6.1 with the respective outlet chambers 6 provided around the outer casing body 12. The outlet chambers 6 at the upper portion of the outer casing body 12 are connected to the fixed spray head 3X or the rotary spray head 3XX by fluid transmission pipes 40, respectively. The outlet chambers 6 at the lower portion of the outer casing body 12 are provided with spray nozzles 07, respectively. The spray nozzle 07 is a rotational flow atomizing core spray nozzle (which may adopt other kinds of spray nozzle according to the requirement). In the embodiment, the control chamber 5 is also provided at the lateral position of the outlet chambers 6, that is, a separation angle (the separation angle may less than, equal to, or larger than 90 degree) is formed between the axis line of the control chamber 5 and the axis line of each outlet chamber 6. In the embodiment, the other reference numerals in FIG. 4 are correspondingly identical with that in embodiment 1. In the spray device according to the embodiment, one thermal sensitive element 2 may also be used to control a plurality of outlet chambers 6 to discharge water, and thus allows a plurality of spray nozzles to spray simultaneously.

### Embodiment 5

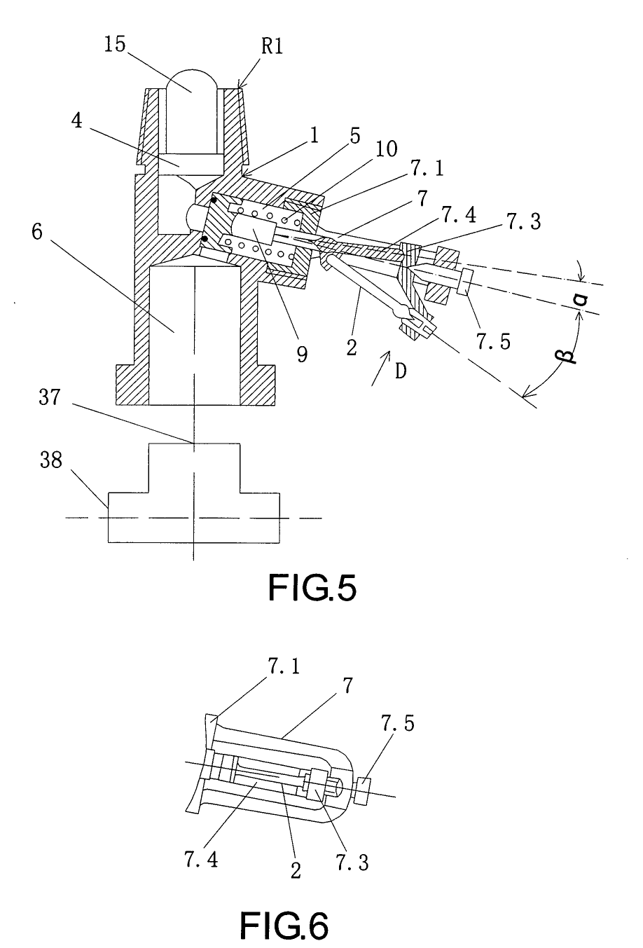

Referring to FIG. 5 and FIG. 6 which is a view seeing from direction D in FIG. 5, this embodiment is similar to embodiment 1. Main differences are that: first, the filter 15 is provided in the inlet chamber 4 of the normally closed valve R1 of the spray device. Second, the spring 10 is provided between the piston element 9 in the control chamber 5 and the end cover 7.1. Third, the outlet chamber of the normally closed valve R1 is connected to the fluid transmission pipe (not drawn in figures) by a connector 37 and a body 38, and then connected to the spray head (not drawn in figures). The thermal sensitive mechanism includes a supporting bar 7.4, the thermal sensitive element 2 and a base plate 7.3 for the supporting bar 7.4 and the thermal sensitive element 2, the thermal sensitive element 2 supports the supporting bar 7.4, the supporting bar 7.4 and the thermal sensitive element 2 are supported on the base plate 7.3, Fourth, the bracket 7 abuts against the base plate 7.3 by a screw 7.5. One end of the supporting bar 7.4 abuts against the tail of the piston element 9, and forms a balance so as to prevent the base plate 7.3 for the supporting bar 7.4 and thermal sensitive element 2 from moving. There are separation angles β (20˜45 degree) and α (4˜10 degree) between the thermal sensitive element 2 and the centerline of the bracket 7 as well as between the supporting bar 7.4 and the centerline of the bracket 7 respectively. The bracket 7 is fixedly connected to the end cover 7.1.

The working principle of the embodiment is that: when a temperature in a monitor region environment is beyond a predetermined temperature, the thermal sensitive element 2 falls off, the balance of the supporting bar 7.4 is broken, and the piston element 9 of the normally closed valve R1 slides backwardly under fluid pressure, so that a pressure fluid flows from the inlet chamber 4 of the normally closed valve R1 into the outlet chamber 6 via the control chamber 5, and then into the fluid transmission pipe connected to the spray head via the connector 37 and body 38.

Since the supporting force applied on the thermal sensitive element 2 only is a small portion of the supporting force applied on the supporting bar 7.4, the thermal sensitive element 2 may be thinner, and the time response time is greatly reduced, and the sprinkling actuation is quicker. Therefore, the thermal sensitive mechanism may be referred to as a rapid response thermal sensitive mechanism. In other embodiments of the present invention, the rapid response thermal sensitive mechanism may be applied to control the operation of the normally closed valve. The other reference numerals in FIG. 5 are correspondingly identical with that in embodiment 1.

The normally closed valve R1 in the embodiment may be reversely disposed, that is, the inlet chamber 4 is downwardly connected to the fire fighting pipe network. A connecting pipe member extending upwardly from the outlet chamber 6 is connected to the corresponding spray head.

### Embodiment 6

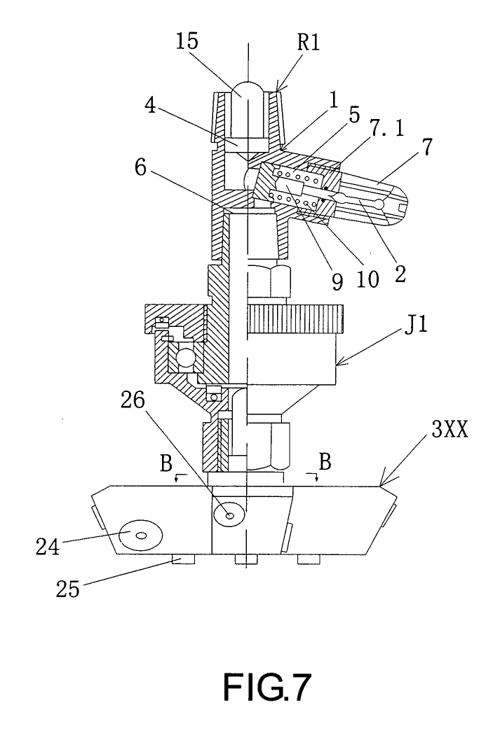

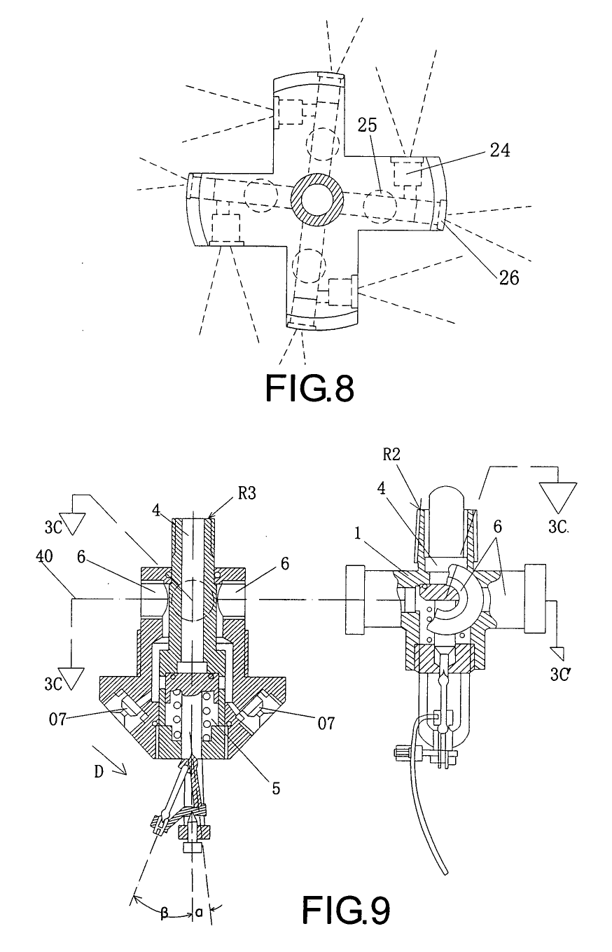

Referring to FIGS. 7 and 8 of the drawings, embodiment 6 is similar to embodiment 1. The differences between embodiment 1 and embodiment 6 are that: first, the filter 15 is provided in the inlet chamber 4 of the normally closed valve R1 of the spray device. Second, the spring 10 is provided between the piston element 9 in the control chamber 5 and the end cover 7.1, one end of the spring 10 is in contact with the end cover 7.1, and the other end of the spring 10 is in contact with the piston element 9. The thermal sensitive element 2 on the bracket 7 adopts a thermal sensitive glass bulb. The outlet chamber 6 of the normally closed valve R1 is connected to a jet thrust fine water mist rotary spray head 3XX by a rotary connector J1, or connected to other rotary sprinkling spray head according to the requirement. FIG. 8 of the drawings shows the spray state of the spray opening, the fine water mist rotary spray head 3XX is provided with a cross-shaped spray head body on which eccentric spray openings 24, non-eccentric spray openings 26 and spray openings 25 are provided. There is an eccentric distance between each eccentric spray opening 24 and a rotation shaft. The spray reaction force of each eccentric spray opening 24 generates a torque relative to the rotation shaft, so as to push the spray head to rotate. The spray openings 25 and non-eccentric spray openings 26 allow a more uniform spray.

The spray device according to this embodiment is a rotary spray device, which may be simply referred to as a jet thrust rotary spray head. The spray device according to the present invention may also form various closed type rotary spray devices by using other fluid dynamic ways. Of cause, the rotary spray head may also be applied to the other embodiments in the present invention.

### Embodiment 7

Referring to FIG. 9 of the drawings, the spray device in the embodiment includes a normally closed valve R2 and a normally closed valve R3 which are used by combination. The inlet chambers of the normally closed valves of the spray device are connected to an automatic fire extinguishing pipe network terminal. The normally closed valve R2 is the same as the normally closed valve of the spray device according to embodiment 3. The normally closed valve R3 is the same as the normally closed valve of the spray device according to embodiment 4. On the basis of embodiment 4, the thermal sensitive mechanism is replaced with the rapid response thermal sensitive mechanism in embodiment 5. The normally closed valve R2 and normally closed valve R3 of the above spray device is positioned and installed in a fire fighting sub-region, and the inlet chamber 4 of each of them is connected with an input pipe. One outlet chamber of the normally closed valve R2 is connected to one outlet chamber 6 of the normally closed valve R3 by a pipeline 40. The other outlet chambers of the normally closed valve R2 are respectively connected to a fine water mist sidewall spray head 3C′ and a fine water mist spray head 3C by pipelines, and each of the other outlet chambers at the upper portion of R3 is also connected to one fine water mist spray head 3C with respective pipeline. The spray heads 3C and 3C′ are provided the region away from the periphery of the normally closed valve R2 and normally closed valve R3. The outlet chambers on the periphery of the lower cone of R3 are directly provided with rotational flow atomizing core spray nozzles 07 (which may be other atomizing core spray nozzles). In the spray device according to the embodiment, no matter which of the thermal sensitive elements of the thermal sensitive mechanisms firstly acts, respective spray nozzles communicating with the normally closed valve R2 and normally closed valve R3 will be opened, so that a plurality of spray nozzles may be actuated to spray simultaneously under the control of the normally closed valve nearest the fire source, thereby increasing the fire extinguishing ability in early time.

By the combination use of the two normally closed valves, all of the spray heads in the fire sub-region may be commonly driven in early time, thereby strengthening the fire extinguishing ability of the fire fighting system. The spray device with combined normally closed valves may be provided more than two, and they are located in a small scope of the same fire fighting division region. However, when used in combination, water supply quantity of the passages and connecting pipes of the normally closed valves should meet the requirement of total water demand quantity of all connected spray heads and spray nozzles (for example, 1″ normally closed valve is used to connect 1/2″ pipeline spray head etc.). Therefore, it is disadvantage to connect overmany spray heads and spray nozzles or connect the spray heads and spray nozzles by a long distance. It is particularly suitable for a fine water mist fire extinguishing system in which a single spray head requires a very small water quantity in the case that fire extinguishing is to be actuated in group or region.

In the above mentioned seven embodiments, the spray heads or spray nozzles which can be used may be varied, and the scope of the present invention is obviously not limited to the spray heads or spray nozzles shown in the drawings. Hereafter, a few kinds of fixed spray heads or spray nozzles which may be engaged with the normally closed valves in above embodiments will be described below.

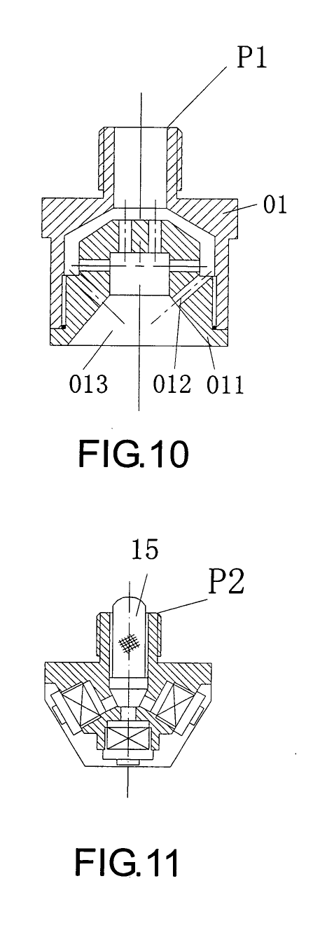

Referring to FIG. 10 of the drawings, a spray head P1 is a gas-water mist spray head. The gas-water mist spray head is provided with a spray head seat 01 and a spray head body 011 on which multiple pairs of symmetric mutual colliding flow holes 012 are provided. The fluid from the outlet of each pair of the mutual colliding flow holes 012 is colliding with each other and meets in a spray head central spray orifice 013. The spray head body 011 provided with multiple pairs of mutual colliding flow holes 012 may singly be served as a mutual colliding flow gas-water atomizing core spray nozzle, that is, the spray head body 011 is directly installed in the outlet chamber of the spray device according to the present invention. Gas-water mixture is input into the spray head P1, and superfine gas-water mist is output.

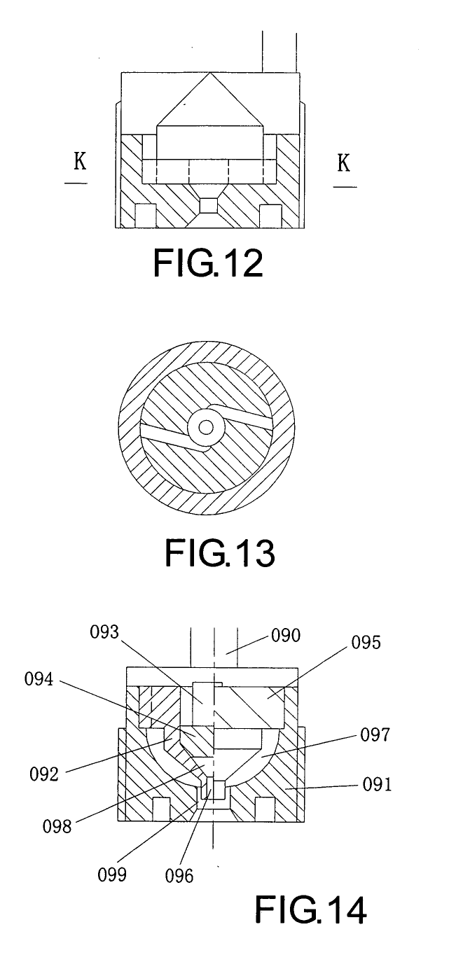

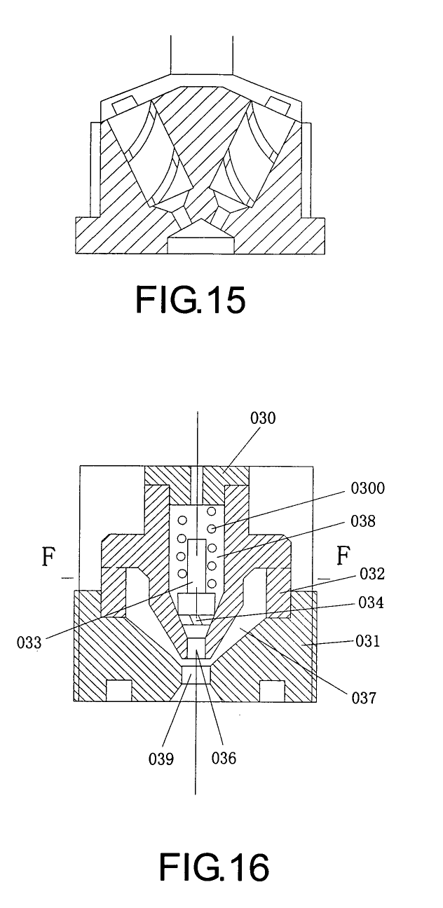

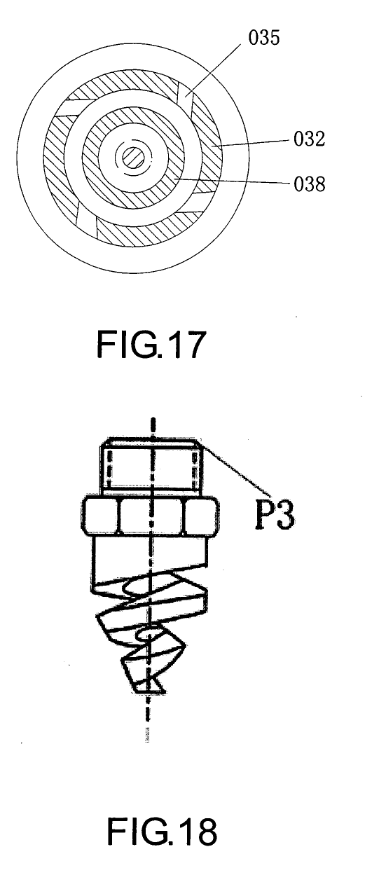

Referring to FIG. 11 of the drawings, P2 is a fine water mist spray head. The filter 15 is provided at the inlet of the spray head seat. Fine water atomizing core spray nozzles are provided on the periphery wall of the spray head seat. The fine water atomizing core spray nozzle may have many options, and may be a centripetal rotational flow atomizing core spray nozzle shown in FIGS. 12 and 13. FIG. 13 is a section view along line K-K in FIG. 12. The atomizing core spray nozzle includes a spray nozzle seat, which is threaded at the periphery and provided with a spray orifice in the center, and a centripetal rotational flow core. A bottom circular boss of the centripetal rotational flow core is insertedly installed on the spray nozzle seat. Two to three centripetal fluid guiding grooves are provided at the periphery of a central hole of the bottom circular boss of the centripetal rotational flow core. The fluid guiding grooves are generally tangential to the periphery of the central hole of the bottom circular boss. The central hole of the bottom circular boss has the same diameter as and communicates with the spray orifice of the spray nozzle seat. The fine water atomizing core spray nozzle may also be a double rotational flow atomizing core spray nozzle shown in FIG. 14. The double rotational flow double spray opening atomizing core spray nozzle includes a spray nozzle seat 091, a rotational flow sleeve 092 and a rotational flow core 093. A plurality of inclined rotational flow grooves 095 are provided on an outer cylindrical surface of a big end of the rotational flow sleeve 092. A rotational flow sleeve spray orifice 096 is provided at the bottom of an inverted conical chamber of the lower portion of the circular hole of the rotational flow sleeve 092. Inclined grooves 094 are provided on a cylindrical-conical surface of the bottom of the rotational flow core 093. A cylindrical surface of the big end of the rotational flow sleeve 092 is insertedly installed in a circular hole of an upper portion of the spray nozzle seat 091. An arc-surface or conical-surface spray nozzle seat chamber with a central spray opening 099 is provided at the lower portion of the spray nozzle seat 091. An approximate funnel-shaped outer rotational flow chamber 097 is formed between the spray nozzle seat chamber and the rotational flow sleeve. An inner rotational flow chamber 098 is formed between the rotational flow sleeve 092 and the rotational flow core 093. The rotational flow sleeve spray orifice 096 is located at the center of the central spray opening 099 of the spray nozzle seat 091, and connected with the central spray opening 099 of the spray nozzle seat 091 in series concentrically or in parallel, so as to form the double rotational flow double spray opening atomizing core spray nozzle. The spray nozzle seat 091 is threadedly connected in the spray head cavity with an input hole 090. The fine water atomizing core spray nozzle may also be a rotor mutual colliding flow atomizing core spray nozzle shown in FIG. 15. The periphery of the atomizing core seat of the rotor mutual colliding flow atomizing core spray nozzle is threaded, in which at least two circular holes each having a shrinkage spray opening are provided. A small rotatable cylinder with a fluid guiding groove is disposed in each circular hole. The fluid guiding groove is a spiral groove or inclined groove. The axes of the respective circular holes as well as the shrinkage spray openings are intersect, so as to form the mutual colliding flow atomizing core spray nozzle. The fine water atomizing core spray nozzle may also be a spray nozzle shown in FIG. 16. Referring to FIGS. 16 and 17 of the drawings, the shown spray nozzle is an atomizing core spray nozzle with a spring and a conical plug. A step-shaped circular hole of a spray nozzle seat 031 is connected with an inverted conical cavity 037. A spray nozzle seat central spray opening 039 is provided at the center of the bottom of the inverted conical cavity 037. A rotational flow sleeve 032 is fixedly installed in the step-shaped circular hole of the spray nozzle seat 031. Two to four tangential rotational flow grooves 035 are provided on an annular wall of the rotational flow sleeve 032. A cylindrical-conical chamber 038 and an inner spray orifice 036 are provided at the center of the rotational flow sleeve 032. The top of the cylindrical-conical chamber 038 is closed by an end cover 030 having a through hole. A step-shaped central cylinder 033 pressed by a spring 0300 is provided in the cylindrical-conical chamber 038 wherein two to three inclined openings are provided in a short conical plug of the step-shaped central cylinder 033. The inner spray orifice 036 is located on the centerline of the spray nozzle seat central spray opening 039. The inner spray orifice 036 and the spray opening 039 are connected in series concentrically or in parallel, so as to form an outer rotational flow atomizing core spray nozzle having the spring and the conical plug. The spray nozzle seat is threadedly connected in the spray head cavity.

Referring to FIG. 18 of the drawings, P3 is a water mist spray head, which is a commonly used hollow conical spiral spray head, and may change the size of spray drop by changing the thick of wall or the shape of tooth.

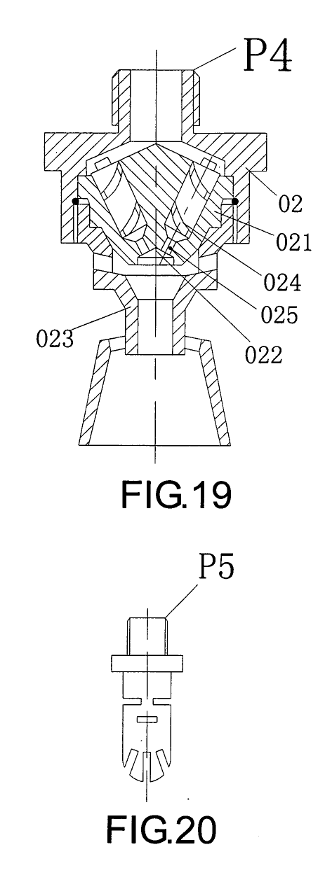

Referring to FIG. 19 of the drawings, the spray head P4 is a foam mist spray head. The foam mist spray head includes a spray head seat 02, a spray head body 021 and a spray head cover 023. Outlets of inclined intersecting holes 025 of the spray head body 021 form a congregation jet flow spray opening 022. Alternatively, rotor holes each having a rotor atomizing core 024 and tapered inclined intersecting holes 025 are provided in the spray head body 021, and outlets of the rotor atomizing cores 024 form the congregation jet flow spray opening 022. The congregation jet flow spray opening 022 and the spray head cover 023 form a venturi air mixing foam spray jet structure. The spray head seat 02 and the spray head cover 023 are threadedly connected, and the spray head body 021 is sandwiched therebetween. Upper and lower circles of air suction holes are provided on the wall of the spray head cover 023. The inner chamber of the spray head cover 023 is formed of a multi-hole air suction chamber, a mixing tube and a diffuse tube. A secondary air suction hole or/and small bubble web may be additionally provided on the diffuse tube.

Referring to FIGS. 15 and 19, if the spray head cover 023 of the above foam mist spray head having the rotor atomizing core is removed, and the periphery of the spray head body 021 is threaded to matchedly connected with the spray head seat 02, it will form a fine water mist spray head having a rotor atomizing core. If the spray head cover 023 and the spray head seat 02 of the above foam mist spray head having the rotor atomizing core is removed, and the periphery of the spray head body 021 is threaded, a fine water mist spray nozzle having a rotor atomizing core is formed. The rotor holes are provided in the above spray head body 021 of the fine water mist spray head with a rotor atomizing core, and the rotor atomizing core 024 is provided in each rotor hole. The rotor hole is provided with a shrinkage spray orifice 025. The axes of the rotor holes may be inclined, parallel or obliquely intersected with each other.

Referring to FIG. 20 of the drawings, P5 is a big water drop spray head. The big water drop spray head 3f is provided with big slotted holes. The position and number of the big slotted holes may be determined according to actual requirement.

The above embodiments demonstrate that in the present invention, the outlet chamber of the normally closed valve of the spray device may be connected to the above various spray heads/nozzles directly or via pipeline, and different kind of spray devices may be formed by connecting with different spray heads.

For example, when the outlet chamber of the normally closed valve is connected with a fixed foam or foam mist spray nozzle or spray head, the spray device of the present invention is a closed type foam sprinkling device or closed type foam mist spray device.

When the outlet chamber of the normally closed valve is connected with a fixed gas-water mist or fine water mist spray nozzle or spray head, the spray device of the present invention is a closed type gas-water mist or fine water mist spray device.

When the outlet chamber of the normally closed valve is connected with a fixed water mist spray head or big water drop spray head, the spray device of the present invention is a closed type water spray device or big water drop closed type sprinkling device.

When the spray head connected with the outlet chamber of the normally closed valve is various rotary spray heads for spray fluid respectively, the spray device of the present invention is a closed type rotary spray device corresponding to such spray flow ways. One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A spray device comprising at least one normally closed valve, and a spray head having a spray nozzle, wherein said normally closed valve comprises a valve body, a piston element, a thermal sensitive mechanism having a thermal sensitive element and a bracket supporting said thermal sensitive mechanism, wherein said valve body has an inlet chamber connected with a pressure flow source, a control chamber receiving said piston element in a slidably movable manner, and an outlet chamber connected with said spray head, wherein said spray device normally operates in a standby state in which said thermal sensitive mechanism supported by the bracket is arranged to press against said piston element which is driven to block physical access between said inlet chamber and said outlet chamber for isolating said inlet chamber from said outlet chamber, wherein said control chamber is located at a lateral position of said outlet chamber in such a manner that axes of said control chamber and said outlet chamber are approximately perpendicular to each other, wherein said spray head has an atomizing chamber, and is supported in a vicinity of said thermal sensitive mechanism and said bracket so as to avoid said thermal sensitive mechanism and said bracket from being blocked.

2. The spray device, as recited in claim 1, wherein said spray nozzle is provided on said valve body, and comprises a spray orifice communicating with said atomizing chamber which communicates with said outlet chamber, wherein said atomizing chamber is one of a rotational flow atomizing chamber, a double rotational flow atomizing chamber, a mutual colliding flow atomizing chamber, a rotor mutual colliding flow atomizing chamber, wherein said mutual colliding flow atomizing chamber is a multi-hole mutual colliding type atomizing chamber and comprises at least two circular holes having respective shrinkage spray orifices, wherein axes of said shrinkage spray orifices intersect with each other, wherein said rotor mutual colliding flow atomizing chamber comprises at least two circular holes having respective shrinkage spray orifices, wherein axes of said shrinkage spray orifices intersect with each other, wherein each of said shrinkage spray orifice has a swirler having a fluid guiding groove;
wherein said spray head, which is a carrier of said spray nozzle, is provided on said outlet chamber, and comprises one of a water mist spray head, a fine water mist, a gas-water mist spray head, and a foam mist spray head; wherein said foam spray head comprises a mutual colliding flow foam spray head comprising at least two atomizing cores provided therein and a plurality of mutual colliding flow spray orifices communicating with and having the same number as the atomizing cores, wherein an air intake cover is provided at a periphery of each of said spray orifices.

3. The spray device, as recited in claim 1, wherein said control chamber further comprises a spring, wherein one end of said spring is supported on said valve body, and another end of said spring is supported on said piston element.

4. The spray device, as recited in claim 1, wherein said thermal sensitive mechanism is a rapid response thermal sensitive mechanism and comprises a supporting bar and a base plate, wherein one end of said thermal sensitive element is supported on an inner end of said supporting bar, while an inner end of said supporting bar is pressed against a tail end of said piston element, wherein an outer end of said supporting bar and another end of said thermal sensitive element are supported on said base plate, which is supported on said bracket.

5. The spray device, as recited in claim 1, wherein said thermal sensitive mechanism comprises a rapid response thermal sensitive wire, wherein one end of said rapid response thermal sensitive wire is connected with said thermal sensitive element of said thermal sensitive mechanism.

6. The spray device, as recited in claim 1, wherein said piston element comprises a seal member provided thereon.

7. The spray device, as recited in claim 1, wherein said valve body is an detachable assembled body, and comprises an outer casing body, a middle body surroundingly embedded by said outer casing body, an annular chamber, and a plurality of outlet chambers, wherein said inlet chamber and said control chamber are located on said middle body, wherein said bracket is fixedly connected on said outer casing body at an outer end of said control chamber; wherein said annular chamber is formed between said outer casing body and said middle body, and communicates with said outlet chambers which are laterally disposed at an upper portion of the outer casing body, and are provided at a periphery of a lower portion of the outer casing body to form a general outlet chamber, wherein said piston element is provided in said control chamber for sealing a communication between said inlet chamber and said annular chamber, wherein at least one of said outlet chambers communicates with one of said spray heads, and at least one of said outlet chambers communicates with one of said spray nozzles inclinedly and spacedly supported towards outside of said valve body.

8. The spray device, as recited in claim 1, further comprising a plurality of normally closed valves and a plurality of said spray heads/nozzles, wherein each of said outlet chambers of said normally closed valves is arranged to communicate with each other, wherein said thermal sensitive mechanism of each of said normally closed valves is capable of actuating at least one spray heads depending on a sensed temperature.

9. The spray device, as recited in claim 1, further comprising a plurality of normally closed valves and a plurality of said spray heads, wherein each of said valve bodies is an integral three-way body, wherein said inlet chamber, said outlet chamber and said control chamber are respectively located at said three-way body, wherein said inlet chamber and said control chamber of each of said normally closed valves have a same axis line, wherein said control chamber, said thermal sensitive mechanism and said bracket are laterally disposed at one side of said axis line, in which a separation angle between said axes of said outlet chamber and said control chamber is in a range of seventy degrees to ninety degrees.

10. The spray device, as recited in claim 1, wherein said valve body is an integral multi-way body and further comprises a plurality of outlet chambers, wherein said inlet chamber, said control chamber and said outlet chambers are respectively located at one body of said multi-way body, wherein said control chamber and said inlet chamber of said valve body have a same axis line, wherein said outlet chambers are connected to said spray head directly or via pipelines, wherein said spray head is one of a fine water mist spray head, a gas-water mist spray head, and a foam mist spray head, wherein said thermal sensitive mechanism is a rapid response thermal sensitive mechanism.

11. The spray device, as recited in claim 1, wherein said spray head is one of a fixed head and a rotary spray head, wherein said rotary spray head comprises a rotary connector and an eccentric spray nozzle which is capable of generating a jet torque, wherein said pipe member comprises a tee-fitting, a plurality of pipe joints and a plurality of pipelines.

12. The spray device, as recited in claim 1, wherein said piston element comprises a piston head and a piston rod which are relatively fixed, wherein said piston rod is hermetically fitted with an outer end hole of said control chamber to hermetically isolate said control chamber from atmosphere, wherein said piston element further has a pressure pilot hole and a piston rod chamber formed between a wall of said control chamber and a surface of said piston rod, wherein said piston head is located between said inlet chamber and said outlet chamber to hermetically isolate said piston rod chamber from said outlet chamber, wherein said pressure pilot hole communicates said inlet chamber wherein an area of a front surface of said piston head withstanding a fluid pressure in said inlet chamber is larger than an area of a back surface of said piston head withstanding a fluid pressure in said piston rod chamber.

13. An operation method of a spray device, wherein inlet chambers of selected normally closed valves are respectively connected to respective branch pipes at a terminal end of a water automatic fire extinguishing pipe network, appropriate type and number of spray heads communicate with corresponding outlet chambers of said normally closed valves directly, and said position of said spray device being determined in a fire fighting sub-region divided according to a requirement, wherein said method comprises the steps of:
i) using said spray device, wherein outlet chambers of said normally closed valves are only connected to one spray head, and said normally closed valves are arranged by a predetermined distance; when fire hazard occurs, each spray head/nozzle connected to said normally closed valve is fixedly spraying;
ii) using said spray device in which said spray head is connected by one of said three-way body and pipelines, and using said spray device, wherein said normally closed valves are arranged by a predetermined distance, there is a predetermined distance between said spray heads communicating with said normally closed valves by said pipelines; when fire hazard occurs, said thermal sensitive mechanisms of said normally closed valves, depending on sensed temperature, control said spray heads communicating with at said periphery of said normally closed valves to spray fixedly and extendingly; and
iii) using said spray device, wherein said normally closed valves are disposed in a fire protection sub-region and are spaced a predetermined distance with each other, said spray heads communicating with said normally closed valves by said pipelines are provided at positions spacing from respective normally closed valves by a set distance and there is a predetermined distance between said spray heads, said thermal sensitive mechanism of any normally closed valve in said spray device is capable of actuating all of said spray heads/nozzles in said combination device depending on sensed temperature, so as to achieve a monitored grouping spray in multi-points.
